(19) United States
(12) Patent Application Publication
(10) Pub. No.: US 2004/0036278 A1
(43) Pub. Date: Feb. 26, 2004

(54) Connecting system for connecting two structural parts in a form- and/or force-locking manner

(76) Inventors: Christoph Erdmann, Ulm (DE); Armin Praska, Rimpar (DE); Stefan Rietzler, Senden-Ay (DE); Deiter Grafl, Ulm (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/410,062

(22) Filed: Apr. 9, 2003

(30) Foreign Application Priority Data
Apr. 10, 2002 (DE) 102 16 721.4

(51) Int. Cl. F16L 3/04

(52) U.S. Cl. 285/136.1

(57) ABSTRACT

The invention relates to a connecting system comprising a connecting element and at least two structural parts. The structural parts are here connected to each other in a form- or force-locking manner through the connecting system which is designed as a spring element. Such connecting systems are preferably used in the automobile sector for connecting structural parts.

The invention relates to a connecting system comprising a connecting element and at least two structural parts. The structural parts are here connected to one another in a form- or force-locking manner via the connecting element. Such connecting systems are preferably used for connecting structural parts in the automobile sector.

From prior art it is known that connecting structural parts in the automobile sector is effected by the corresponding modification of the structural parts.

This includes for example a structural part having an undercut. A spring, e.g. a snap-in hook, then engages in the undercut. The disadvantage here is that the structural part provided with. the connection piece is expensive and thus cost-intensive to produce since the tooling requirements in the manufacture of such injection-moulded parts are very high.

A further variant makes provision for a recess to be milled subsequently into the connection piece after the structural part has been produced. This variant also has the considerable disadvantage of expensive and cost-intensive production.

Other solutions, which are known from prior art, are based on such structural parts being glued to one another. This brings with it, however, the disadvantages that considerable problems can arise in respect of process reliability which lead to high reject rates. At the same time, glue connections show clear disadvantages in relation to the tightness of the connection and the cleanness of the structural parts.

What is common to all these techniques is that the required undercuts, especially in the case of structural parts formed from thermosetting material, can only be realised by means of expensive tool technology.

Proceeding therefrom, the object of the present invention was to eliminate the described disadvantages of the prior art and to make available a connecting system which can be manufactured with low outlay, with the aim of reducing costs.

This object is accomplished by the connecting system of this type having the characterising features of claim 1. The further dependent claims show advantageous developments. The use of the connecting systems according to the invention is described in claim 13.

According to the invention a connecting system is made available which comprises at least two structural parts and a connecting element, a connecting element designed as a spring element being secured to a first structural part, and being connected to at least one second component in a force- and/or form-locking manner.

The connecting element is here attached to a first structural part via the spring element. The spring element is generally so designed that a reversible attachment to the structural part takes place. This can be realised for example in that a connecting element with a spring hook geometry is guided over a connection piece of the structural part and the connecting element is deformed by contact pressure in such a way that the individual hooks dig into the connection piece. However it is also possible for the attachment to take place in a reversible manner, i.e. for the dug-in hooks to be subsequently released again and for the connecting element to be separated from the structural part.

In a variant of the connecting system, the spring element, corresponding with a first structural part having a connection piece, is designed as an internal geared disc, the spring power acting towards the centre of the geared disc. The internal geared disc corresponding in a form-locking manner with the connection piece is here guided over the connection piece and then deformed by corresponding contact pressure in such a way that the teeth engage in the connection piece for a reversible or irreversible fastening.

A further variant provides for the spring element corresponding with a structural part having a recess to be designed as a bracing connecting element, and for the spring power to act opposite to the direction of the centre of the connecting element. The bracing connecting element can here be designed especially as an external geared disc which is introduced into a recess of the first structural part, e.g. a blind hole, the geared disc being so deformed by contact pressure that the teeth engage in the blind hole and dig into this in a reversible or irreversible manner.

Preferably the second structural part is designed as a coupling element which is connected to a third structural part in a force- and/or form-locking manner. According to the geometry of the first structural part, the coupling element can be designed here as a clamping sleeve, if the structural part has a connection piece, or in any shape at all if the structural part has a blind hole.

It is here particularly preferred for the coupling element to have, at least in portions, on its outer periphery an undercut which corresponds in a form-locking manner with the third structural part. The undercut can here be designed both as a thickening in the form of a bead or as a depression in the form of a recess, which can be produced for example by injection moulding. The undercut can extend over the entire periphery of the coupling element or also be designed as at least one peg. By means of the undercut it is made possible for any locking, snap, clip and/or bayonet connections to be realised between the coupling element and the third structural part. This is particularly advantageous when quick connecting systems, so-called quick connectors, are used.

In a special embodiment, the bonnet of a motor-operated valve represents the first structural part. This motor-operated valve bonnet has a vent connecting piece to which a bracing disc formed from spring steel is secured as a connecting element. The fastening takes place here by corresponding contact pressure which makes possible the digging of the individual teeth into the connecting piece. The connecting element is connected in turn to a coupling element designed as a clamping sleeve. The coupling element and connecting element can be connected for example by the connecting element being clamped into the coupling element. It is also possible for the connecting element also to have on its outer periphery teeth which dig into the inner periphery of the clamping sleeve. The coupling element is connected in turn to a third structural part, especially to a venting hose provided with a quick connector. Quick connectors of this type are already known from prior art. The connection here is preferably made in a form-locking manner, i.e. the coupling element has a previously described thickening or depression on its outer periphery which can correspondingly lock, clip or snap with the quick connectors.

The spring element preferably has a higher material hardness by comparison with the first element. This given fact makes it possible for the spring elements to dig efficiently into the first structural part and abrasive destruction, which can lead to loosening of the connection, can be avoided on the spring element.

As materials for the second structural part or the coupling element and the third structural part, can be considered, independently of one another, metals, alloys, ceramic materials, plastics materials and/or composites of same. As the plastics materials should be mentioned above all thermosetting plastic resins, thermoplastic materials, elastomers and/or thermoplastic elastomers (TPE).

The connecting element designed as a spring element is formed preferably from metals, alloys, ceramic materials and/or composites of same. It is particularly preferred for the spring element to consist of spring steel.

For the connection of the second structural part or of the coupling element with the spring element, all joining and connecting techniques known from prior art can be considered. However some techniques should be emphasised here since they are particularly suitable for the purpose mentioned. This includes bonding, welding, extrusion-coating and mechanical deforming. In the case of thermoplastic coupling elements, thermal deforming is particularly suitable. Further connecting techniques are based on clip, snap and/or bayonet connections.

In a further advantageous development of the subject matter of the invention, the connecting system has at least one sealing element, which makes possible sealing of the first structural part from the second or third structural parts.

The connecting systems according to the invention are used mainly in the automobile sector for securing various structural parts. A particular embodiment, which is only mentioned here by way of example, is the coupling of venting hoses to the bonnets of motor-operated valves.

The subject matter of the application will be described in greater detail with the aid of the following figures, without limiting said subject matter to these embodiments.

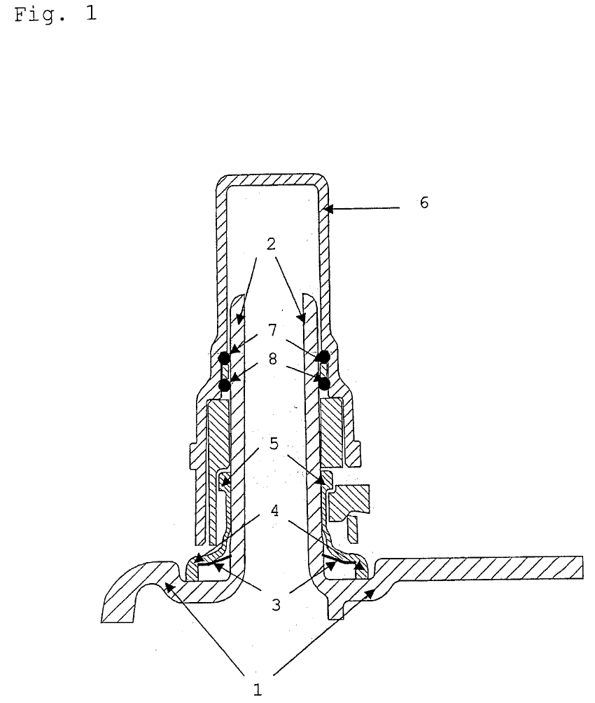

FIG. 1 shows the axial sectional view of a connecting system according to the invention,

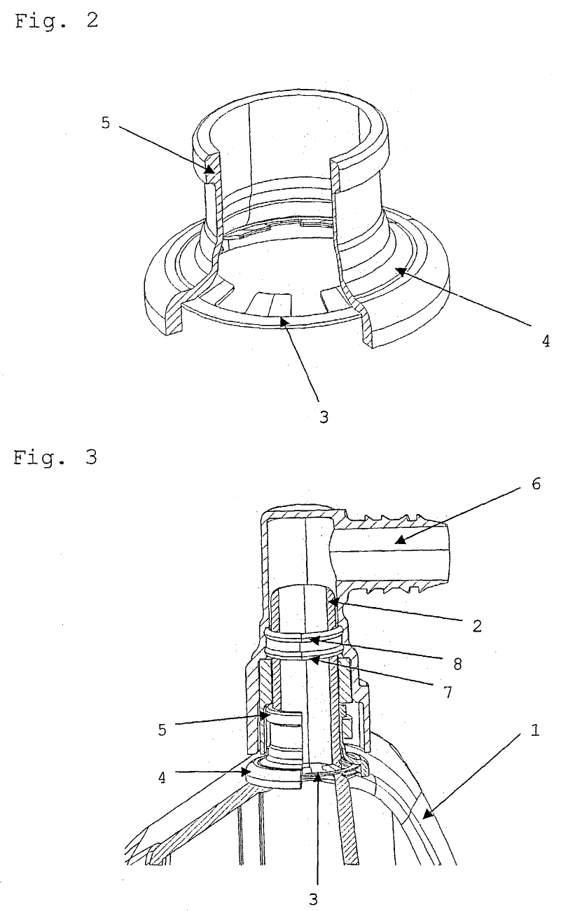

FIG. 2 shows the schematic view of a clamping sleeve in connection with a spring element,

FIG. 3 shows diagrammatically the connecting system according to the invention in a perspective sectional view,

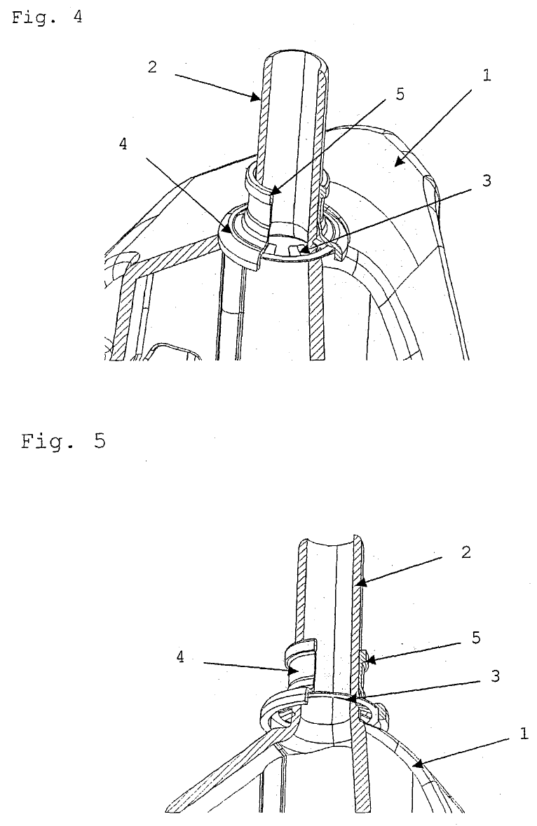

FIGS. 4 and 5 show diagrams of the arrangements of a clamping sleeve on the connection piece of a bonnet of a motor-operated valve.

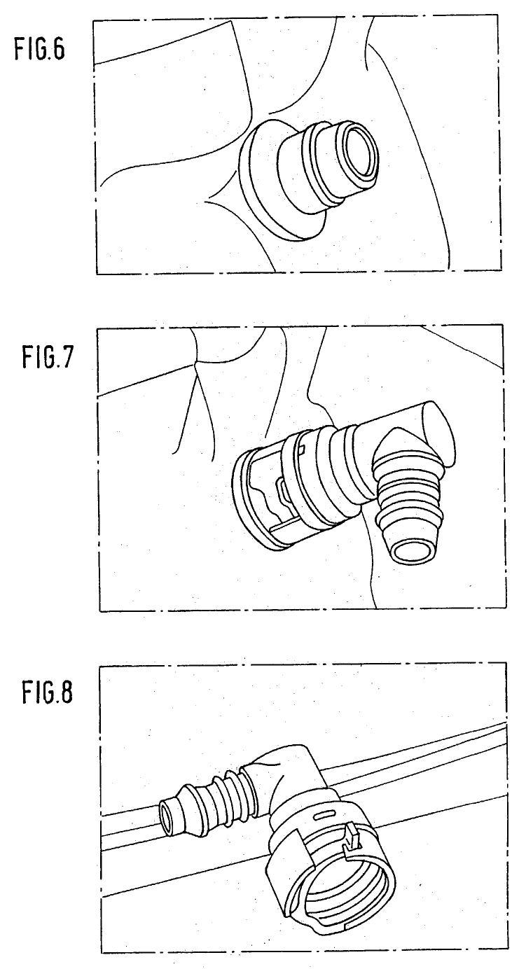

FIG. 6 shows the photographic view of the arrangement of a clamping sleeve on the connection piece of the bonnet of a motor-operated valve,

FIG. 7 shows the photographic view of a quick connector fastened to a bonnet of a motor operated valve,

FIG. 8 shows the photographic image of a quick connector,

FIG. 9 shows the photographic image of a clamping sleeve,

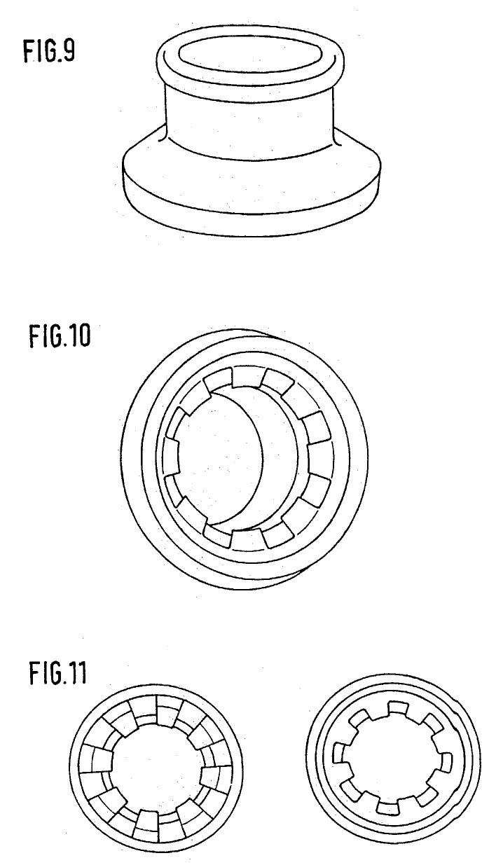

FIG. 10 shows the photographic image of a clamping sleeve and a spring element attached therein, and

FIG. 11 shows the photographic image of two variants of the fastening of the spring element in the clamping sleeve.

In FIG. 1 is represented the fastening of a quick connector 6 to a bonnet 1 of a motor-operated valve. The valve bonnet 1 here has a connection piece 2, on which the clamping sleeve 4 is placed with the associated spring element 3. By contact pressure in the direction of the bonnet of the motor-operated valve, the spring element 3 can be stopped with the clamping sleeve 4 on the connection piece 2. At the same time, the clamping sleeve 4 has a bead 5 which corresponds in a form-locking manner with the quick connector 6. On the inner side of the quick connector 6, facing the connection piece, said connector has in addition two rubber rings 7 and 8 which serve to seal the quick connector from the valve bonnet. The same circumstance is illustrated in FIG. 3, a perspective sectional view having been selected here.

In FIG. 2 is illustrated a clamping sleeve 4 which has at its upper edge a bead 5 which corresponds in a form-locking manner with a further structural part, e.g. a quick connector. A spring element 3 is here secured to the inner side of the clamping sleeve.

FIGS. 4 and 5 show in perspective sectional view the fitting of a clamping sleeve 4 and an associated spring element 3 to the connection piece 2 of a bonnet 1 of a motor-operated valve. The spring teeth of the spring element 3 are here so aligned that it becomes possible for the teeth to dig into the connection piece 2.

In FIG. 6 is illustrated the fitting of a clamping sleeve to a connection piece of a bonnet of a motor-operated valve. To said valve is secured in turn, according to FIG. 7, a quick connector which is shown further enlarged in FIG. 8. In FIG. 10 is represented the force-locking connection of a spring element in a clamping sleeve. In FIG. 11 are shown two variants of the fastening of the spring element to the clamping sleeve. Thus the spring element according to the left-hand variant in FIG. 11 has spring teeth both on the inside and on the outside. The spring teeth located on the outside can here dig into the clamping sleeve, whilst the teeth on the inside can dig into the first structural part, e.g. a connection piece. The right-hand variant in FIG. 11 illustrates the force-locking attachment of the spring element in the clamping sleeve by bonding. For this bonding, all the variants of bonding known from prior art can be considered.

1. Connecting system comprising at least two structural parts and a connecting element, characterised in that a connecting element (3) designed as a spring element is attached to a first structural part (1), said connecting element being connected to at least one second structural part (4) in a force- and/or form-locking manner.

2. Connecting system according to claim 1, characterised in that the spring element (3) corresponding with a first structural part (1) which has a connection piece (2) is designed as an internal geared disc and the spring power acts towards the centre of the disc.

3. Connecting system according to claim 1, characterised in that the spring element (3) corresponding with the structural part which has a recess is designed as a bracing connecting element, and the spring power acts opposite to the direction of the centre of the spring element.

4. Connecting system according to at least one of the preceding claims, characterised in that the second structural part is designed as a coupling element (4) which can be connected to a third structural part (6) in a force- and/or form-locking manner.

5. Connecting system according to claim 4, characterised in that the coupling element (4) has, at least in portions, on its outer periphery, a depression and/or a thickening corresponding with the third structural part (6) in a form-locking manner.

6. Connecting system according to claim 5, characterised in that the first structural part (1) is designed as a bonnet of a motor-operated valve with a vent connecting piece (2), the spring element (3) as a bracing disc of spring steel, the coupling element (4) as a clamping sleeve, and the third structural part (6) as a vent hose provided with a quick connector.

7. Connecting system according to at least one of the preceding claims, characterised in that the spring element (3) has a higher material hardness by comparison with the first structural part (1).

8. Connecting system according to at least one of the preceding claims, characterised in that the second structural part or the coupling element (4) and/or the third structural part (6) is made of a metal, an alloy, a ceramic material, a plastics material, e.g. a thermosetting plastic resin, a thermoplastic material, an elastomer or a thermoplastic elastomer (TPE) and/or composites thereof.

9. Connecting system according to at least one of the preceding claims, characterised in that the spring element (3) is made of a metal, an alloy, a plastics material, a ceramic material, and/or composites thereof.

10. Connecting system according to claim 7, characterised in that the spring element (3) is made of spring steel.

11. Connecting system according to at least one of the preceding claims, characterised in that the second structural part or the coupling element (4) is connected to the spring element (3) by bonding, welding, extrusion-coating and mechanical deforming as well as, in the case of thermoplastic coupling elements, by thermal deforming, clamping and a snap and/or bayonet connection.

12. Connecting system according to at least one of claims 1 to 9, characterised in that the connecting system has at least one sealing element (7, 8).

13. Use of the quick-connecting element according to at least one of claims 1 to 8 for fastening structural parts in the automobile sector.
